(19) United States
(12) Patent Application Publication
(10) Pub. No.: US 2002/0123811 A1
(43) Pub. Date: Sep. 5, 2002

(54) Production management system and program

(75) Inventor: Miyoshi Yoshida, Tokyo (JP)

Correspondence Address: McDermott, Will & Emery, 600 13th Street, N.W., Washington, DC, 20005-3096, US

(73) Assignee: MITSUBISHI DENKI KABUSHIKI KAISHA

(21) Appl. No.: 09/950,782

(22) Filed: Sep. 13, 2001

(30) Foreign Application Priority Data
Mar. 5, 2001 (JP) 2001-060527

(51) Int. Cl. G06F 19/00

(52) U.S. Cl. 700/96; 700/95; 700/104; 700/108

(57) ABSTRACT

The present invention defines three types of data, namely production flow data 6, work condition data 8, and product work condition assignment data 10, creates manufacturing method information 1 using their data formats, and registers it so that these data can be combined to generate work record information 2.

### BACKGROUND OF THE INVENTION

1. Field of the Invention

The present invention relates to a production management system for managing product-manufacturing methods and work records for production of products by use of a computer, and a production management program. Specifically, the present invention relates to a production management system and program which employ characteristic data structures for managing manufacturing method information and work record information.

2. Background Art

With the recent diversification of user's needs, there have been an increasing number of cases in which many types of products are manufactured using the same production line. To accomplish this, it is necessary to manage the types of work to be performed for each product, their conditions, and work results. However, if such management is to be applied to production of semiconductor devices, which are fabricated through many stages of a work process, a very complicated production management method must be employed.

To solve the above problem, for example, Japanese Laid-Open Patent Publications Nos. 5-204934 (1993) and 6-267805 (1994) each disclose a production management apparatus using a computer. These systems manage the types of works to be performed and apparatuses to be used, and work conditions using databases. Japanese Laid-Open Patent Publication No. 7-21271 (1995), on the other hand, discloses a support system for employing optimum work conditions, wherein the support system manages manufacturing conditions as well as collecting work records to indicate them on an input screen for manufacturing conditions. Furthermore, Japanese Laid-Open Patent Publication No. 2000-182917 discloses a system for managing manufacturing conditions and measurements of manufactured products so as to re-set manufacturing conditions based on the measurements.

In a system such as those disclosed in the above Japanese Laid-Open Patent Publications Nos. 7-21271 and 2000-182971, where in addition to management of manufacturing conditions and manufacturing results, the manufacturing conditions are re-set based on judgement made by a worker or according to the manufacturing results, it is necessary to be able to easily re-set them. Because such a system is not practical if changing the manufacturing conditions requires interruption of current work or shutdown of the system.

However, the system disclosed in the above Japanese Patent Laid-Open Publication No. 2000-182917 uses a data structure made up of “a data area storing the names of manufacturing processes and the names of measuring processes in the order of production” and “another data area storing one or a plurality of manufacturing conditions for each process name” as described in its specification. In a method as described above in which the name of each process and its work conditions are collectively managed as a single piece of data, when a manufacturing process A is required for manufacture of both a product 1 and a product 2 as shown in FIG. 13, for example, manufacturing conditions a1 and a2 are registered and managed for each of the products 1 and 2 separately. In this case, to change the contents of the manufacturing condition al, it is necessary to change all of the separately registered manufacturing conditions al (the duplicated data), imposing a heavy work load. Furthermore, if a change in the conditions necessitates a change in the number of the processes employed, it is necessary to change the data format itself, which may require shutdown of the system and therefore is not desirable in system operation.

### Summary of the Invention

To solve the above problems, it is an object of the present invention to provide a production management system for flexibly and efficiently managing information as to types of work to be performed, conditions, and work results for each product even when the information is complicated and large in quantity.

Another object of the present invention is to provide a production management system which can flexibly deal with a case in which it is necessary to add a work process during work for some reason.

A production management system of the present invention manages a product manufacturing method and a work record for production of a product by use of a computer. According to one aspect of the present invention, the system comprises a manufacturing method management database, production flow data obtaining means, product work condition assignment data obtaining means, work condition data obtaining means, work record data generating means, and a work record management database.

The manufacturing method management database stores three types of manufacturing method information. First manufacturing method information is composed of pieces of production flow data each indicating a type and a sequence number of a work process for producing a product. Second manufacturing method information is composed of pieces of work condition data each indicating a work condition for performing a work process. And third manufacturing method information is composed of pieces of product work condition assignment data each assigning a work condition suitable for production of a product to a work process. The first manufacturing method information, the second manufacturing method information, and the third manufacturing method information are registered in the manufacturing method management database in such a way that they are associated with one another.

The production flow data obtaining means selects and obtains, based on product information supplied from an input apparatus, production flow data for a product indicated by the product information from the first manufacturing method information.

The product work condition assignment data obtaining means selects and obtains, from said third manufacturing method information, product work condition assignment data which includes the same work process as that included in the obtained production flow data and the same product information as said product information.

The work condition data obtaining means selects and obtains, based on the obtained product work condition assignment data, work condition data indicating a work condition assigned from said second manufacturing method information by the product work condition assignment data;

The work record data generating means combines predetermined data items included in the obtained production flow data, the obtained product work condition assignment data, and the obtained work condition data to generate work record data.

The work record management database stores work record information composed of pieces of generated work record data.

Information managed by the production management system according to the present invention is divided into two main types: “manufacturing methods” for products whose production is managed, and “work records” of works performed on production lines. To discriminate these two types of information, this specification defines two types of databases: the “manufacturing method management database” and the “work record management database”. However, these are conceptual definitions to classify information to be processed. Therefore, these databases and storage devices storing them need not necessarily be separated from one another.

A “manufacturing method” is literally a method for manufacturing a product. In addition, to manage the “manufacturing method” information, the product management system according to the present invention classifies it into three types of information: first manufacturing method information made up of pieces of production flow data, second manufacturing method information made up of pieces of work condition data, and third manufacturing method information made up of pieces of product work condition assignment data.

Generally, work steps carried out for producing a product on a production line are grouped into work groups for their management. This work group is called a “work process”. That is, a series of work steps (hereinafter referred to as a “production flow”) carried out until the product is completed can be managed by grouping them into a plurality of work processes and setting their sequence. Accordingly, the production management system according to the present invention defines production flow data in which a work process and its sequence number (one sequence number corresponds to only one work process and vice versa in a single sequence) are included. With this arrangement, it is possible to manage a production flow as a set of a plurality of pieces of production flow data. The first manufacturing information is made up of pieces of pieces of such production flow data.

Next, note a single work process itself. Before each work process is performed, it is necessary to give the workers instructions as to work conditions. The work conditions include, for example, processing conditions such as temperatures and duration, or specifications such as finished dimensions. Generally, the number of work conditions set for each process is not necessarily limited to one. Furthermore, the same work condition may be used by different processes. To handle these cases, the production management system according to the present invention defines work condition data in which a setting item such as “temperature” and its setting value such as “35°C.” are included. With this arrangement, it is possible to manage work conditions separately from production flows. The second manufacturing method information is made up of pieces of such work condition data.

It should be noted that the corresponding relationship between a work condition and a work process to which it is applied is not fixed since more and more diversified products have been produced these days. For example, in many cases, a high-performance version and an economical version of a product are available, wherein the economical version has performance a little lower than the high-performance version, but they have the same functions. In this case, it is natural that they may be produced using the same production flow but different process conditions. To cope with this, the production management system according to the present invention defines product work condition assignment data in which a product type and work condition data indicating a work condition suitable for producing the product type are included for each process so as to be able to set a work condition for each product type. With this arrangement, it is easy to manage various work conditions and apply suitable ones to each product type. The third manufacturing method information is made up of pieces of such product work condition assignment data.

On the other hand, the term “a work record” refers to types of information such as those entered into a work log. Generally, a work log often keeps records of not only performed work but also instructions received from the designer or the responsible worker to carry out the work. That is, the term “a work record” refers to not only information generated as a result of performing a work, such as information indicating whether the work is successful, but also information as to instructions (and work conditions to be applied, etc.) given before the work is performed. Unlike the manufacturing method, the work record is added and stored each time a product is produced.

To sum up, the production management system according to the present invention is characterized in that it defines three types of data, namely “production flow data”, “work condition data”, and “product work condition assignment data”, and manages various types of production management information according to these defined data formats while combining them as necessary. By employing the production management system, it is possible to eliminate the need for duplicating management information (therefore management of only a minimum of production information is required), saving the storage area. Furthermore, it is possible to manage a number of various production flows by employing as many combinations of the various types of production management information.

As described above, the work record includes such information as conditions given before work is performed. And in many cases, the worker carries out the work while checking the given information, and adds information indicating whether the work is successful and the condition of the finished product after the work. Therefore, the above production management system preferably further comprises work record display means for displaying desired work record data selected from said work record information on a display apparatus; and work record update means for adding information on a work result supplied from an input apparatus to said work record information to update said work record management database. With this arrangement, a worker responsible for each work process can display its work conditions on the screen, and add information after the work.

On the other hand, the production flow data, the product work condition assignment data, the work condition data may have the following specific data structures.

For example, the production flow data may have a structure made up of data items including a production flow identifier for identifying a production flow composed of pieces of the production flow data; a product identifier for identifying a product; a work process identifier for identifying a work process; and a sequence number of the work process. Each identifier may use the above respective name as it is in the production flow data, or alternatively a fixed-length identification symbol may be assigned to each identifier if the name is considered to be too long.

Further, the product work condition assignment data may have a structure made up of data items including a work process identifier for identifying a work process; a product type indicating a type of a product; and a work condition identifier for identifying a work condition.

Still further, the work condition data may have a structure made up of data items including a work condition identifier for identifying the work condition data; a setting item; and a setting value.

The setting item and the setting value included in the above work condition data can be used for managing a condition of a process applied to a work target or managing a finish specification to be satisfied by a work target, or both.

As is the case with information on manufacturing methods, it is possible to reduce a burden on management of work record information by appropriately classifying and registering it for management. Specifically, the work record information is managed as information comprising three work record information. First work record information is composed of pieces of product work record data each indicating a work result for a product. Second work record information is composed of pieces of process record data each indicating a work result for a work process. And third work record information is composed of pieces of applying condition data each indicating a work condition applied to work.

In this case, the product work record data and the process record data may have the following specific data structures.

For example, the product work record data has a structure made up of data items including a product production order date, a product production start date, a product production completion date, and information indicating whether a manufactured product is nondefective or defective.

Further, the process record data may have a structure made up of data items including a work process start time, a work process completion time, a responsible worker, and information indicating whether a performed work is successful or unsuccessful.

It is desirable that the applying condition data has a structure similar to that of the work condition data included in the manufacturing method information.

Next, description will be made of means for flexibly dealing with a case in which it is necessary to add a work process during work for some reason. To accomplish the above object, the production flow data employed in the above production management system may have a structure made up of, for example, data items including a first production flow identifier for identifying a production flow composed of pieces of the production flow data itself, a product identifier for identifying a product, a work process identifier for identifying a work process, a sequence number of the work process, and a second production flow identifier for specifying an insertion production flow indicating another work process to be inserted after the work process in a predetermined case.

That is, a production flow indicating work to be carried out when a problem arises is registered beforehand so that it is possible to refer to it when necessary. One method for indicating and referring to the production flow may be to display the name of the production flow to be inserted on the screen so that the worker can take necessary measures. However, the production management system may preferably further comprise insertion production flow data obtaining means for selecting and obtaining production flow data for a production flow specified by the second production flow identifier in the predetermined case. The production management system generates work record data for a work process included in the obtained insertion production flow data to additionally register the generated work record data with the work record management database by use of the product work condition assignment data obtaining means, the work condition data obtaining means, and the work record data generating means.

With this arrangement, when a problem arises, it is only necessary for the worker to refer to generated work record data, as is the case with a normal work process, to take necessary measures, eliminating the need for taking a number of hasty operations.

It should be noted that the insertion production flow (a production flow to be inserted) is a type of production flow having the same data structure as that of the ordinary production flow even though it has a little different use purpose. Accordingly, the above product work condition assignment data obtaining means, work condition data obtaining means, and work record data generating means can handle the insertion production flow in the same way as they do the ordinary production flow.

Other and further objects, features and advantages of the invention will appear more fully from the following description.

### BRIEF DESCRIPTION OF THE DRAWINGS

FIG. 1 is a diagram showing the configuration of a production management system according to an embodiment of the present invention.

FIG. 2A is a diagram showing the structure of production flow data.

FIG. 2B is a diagram showing an example of first manufacturing method information.

FIGS. 3A, 3C, and 3E are diagrams each showing a structure of work condition data.

FIGS. 3B, 3D, and 3F are diagrams each showing an example of second manufacturing method information.

FIG. 4A is a diagram showing the structure of product work condition assignment data.

FIG. 4B is a diagram showing an example of third manufacturing method information.

FIG. 5 is a diagram showing the relations among the three types of manufacturing method information.

FIG. 6 is a flowchart showing a method for updating manufacturing method information.

FIG. 7A is a diagram showing the structure of product work record data.

FIG. 7B is a diagram showing an example of first work record information.

FIG. 8A is a diagram showing the structure of process record data.

FIG. 8B is a diagram showing an example of second work record information.

FIGS. 9A, 9C, and 9E are diagrams each showing the structure of applying condition data.

FIGS. 9B, 9D, and 9F are diagrams each an example of third work record information.

FIG. 10 is a flowchart showing a production management flow according to the present embodiment.

FIG. 11 is a flowchart showing the process of generating work record information.

FIGS. 12A, 12B, and 12C are diagrams showing an example of generated work record information.

FIG. 13 is a diagram showing a data structure employed by a conventional production management system.

### DETAILED DESCRIPTION OF THE INVENTION

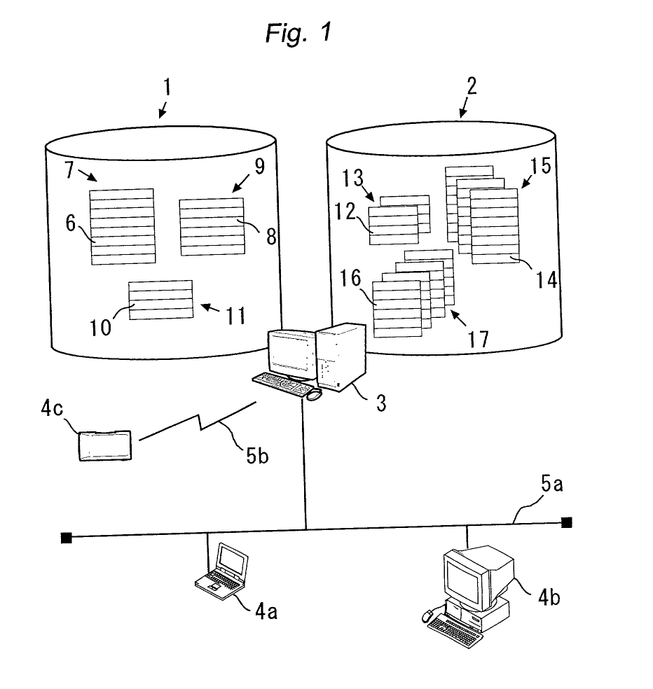

A preferred embodiment of the present invention will be described with reference to the accompanying drawings. FIG. 1 is a diagram showing the configuration of a production management system according to the present embodiment. As shown in the figure, the production management system comprises a server computer 3 for managing manufacturing method information 1 and work record information 2 as databases; a terminal 4 used for a manager or a worker to refer to or update the contents of the databases; a network 5 enabling the server computer 3 and the terminal 4 to exchange data. The server computer 3 has installed thereon a general-purpose database system and a production management system of the present invention. It should be noted that to store the manufacturing method information 1 and the work record information 2, two separate databases may be employed, or alternatively a single database may be used to store both of them. Furthermore, the terminal 4 can take any form so long as it has display, input, and communication functions and is capable of running a production management program of the present invention. The terminal 4 may be a personal computer 4a or 4b having a CRT and a keyboard, or a portable terminal 4c having an LCD screen and a pen input device. Similarly, the network 5 need not necessarily be a wired network 5a. The network 5 may be a wireless LAN 5b instead. Furthermore, these facilities need not necessarily be dedicated for the production management system. They may be shared by other systems having different purposes.

The manufacturing method information 1 includes first manufacturing method information 7, second manufacturing method information 9, and third manufacturing method information 11 which are registered in a database so that they are associated with one another. The first manufacturing method information 7 is made up of pieces of production flow data 6; the second manufacturing method information 9 is made up of pieces of work condition data 8; and the third manufacturing method information 11 is made up of pieces of product work condition assignment data 10. The work record information 2, on the other hand, includes first work record information 13, second work record information 15, and third work record information 17 which are registered in a database so that they are associated with one another. The first work record information 13 is made up of pieces of product work record data 12 each indicating a work result for a product; the second work record information 15 is made up of pieces of process record data 14 each indicating a work result for a process; and the third work record information 17 is made up of pieces of applying condition data 16 indicating a work condition applied to work.

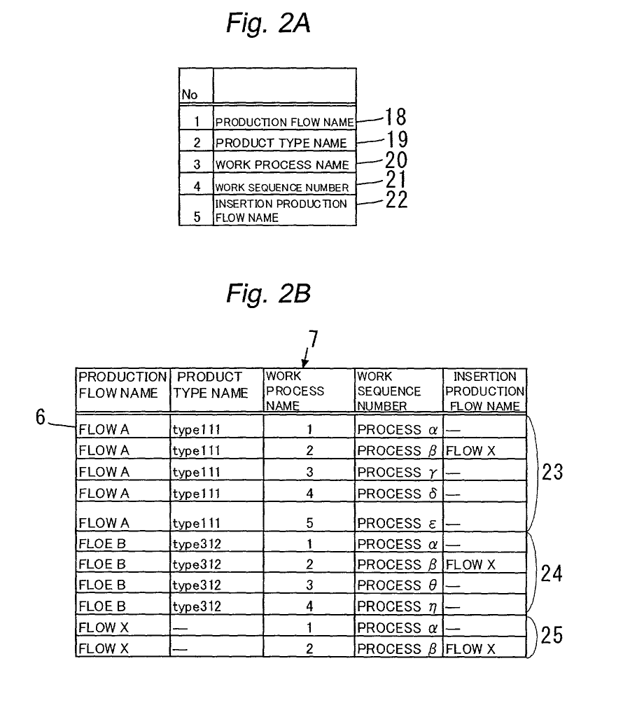

FIG. 2 is a diagram showing the structure of the production flow data 6 and an example of the first manufacturing method information 7. As shown in FIG. 2A, the production flow data 6 is defined as data having a structure made up of data item fields such as a production flow name field 18, a product type name field 19, a work process name field 20, and a work sequence number field 21. Each production flow name field 18 indicates the name of a respective production flow. Each product type name field 19 indicates the type name of the product manufactured through a respective production flow. Each work process name field 20 indicates the name of a work process constituting a respective production flow and is expressed using such a description as “electron beam irradiation” or “development”. The work sequence number field 21 indicates the sequence number of the process indicated by the work process name field 20 in the production flow indicated by the production flow name field 18.

In addition to the above data item fields, the present embodiment defines an insertion production flow name field 22. This item field manages a production flow which indicates processes to be performed after the work process indicated by the work process name field 20 has failed. Some insertion production flow name fields 22 may be left blank.

FIG. 2B is a diagram showing an example of the first manufacturing method information made up of pieces of production flow data 6. As shown in the figure, a production flow named “flow A” is made up of 5 pieces of production flow data 23, while a production flow named “flow B” is made up of 4 pieces of production flow data 24. A production flow named “flow X” is made up of two pieces of production flow data 25.

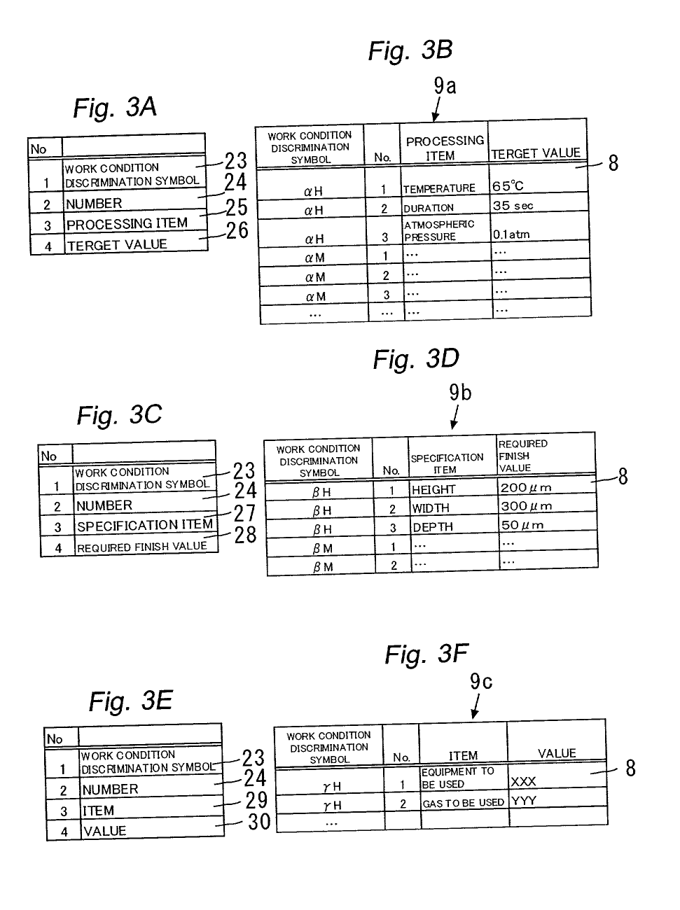

FIG. 3 is a diagram showing the structure of the work condition data 8 and an example of the second manufacturing method information 9. The present embodiment defines three types of data structures for the work condition data 8 each used according to a respective type of data to be managed.

FIG. 3A is a diagram showing a data structure for managing work process conditions such as temperature, duration, and pressure. The data structure is made up of data item fields such as a work condition discrimination symbol field 23 for discriminating one work condition from another, a number field 24 for facilitating management of a plurality of conditional items, a process item field 25, and a target value field 26. An item name such as “temperature” or “duration” is set for the process item field 25, while numerical value data such as “65° C.” or “35 sec” is set for the target value field 26. FIG. 3B shows second manufacturing method information 9a made up of work condition data 8 having a structure as described above.

FIG. 3C is a diagram showing a data structure for managing a specification that must be satisfied for work. The specification concerns dimensions, weight, etc., and is managed as a work condition. Its data item fields include the work condition discrimination symbol field 23, the number field 24, a specification item field 27, and a required finish value field 28. A specification item name such as “height” is set for the specification item field 27, while a value such as “200 μm” is set for the required finish value field 28. FIG. 3D shows second manufacturing method information 9b made up of work condition data 8 having a structure as described above.

In addition, the present embodiment defines the structure shown in FIG. 3E to manage equipment, gases, chemicals, etc. to be used, as work conditions. This data structure is made up of data item fields such as the work condition discrimination symbol field 23, the number field 24, an item field 29 for holding a management item name, and a value field 30. For example, the item field 29 and the value field 30 hold data such as “gas to be used” and “CF₄ gas”, respectively. FIG. 3F shows second manufacturing method information 9c made up of work condition data 8 having the structure described above.

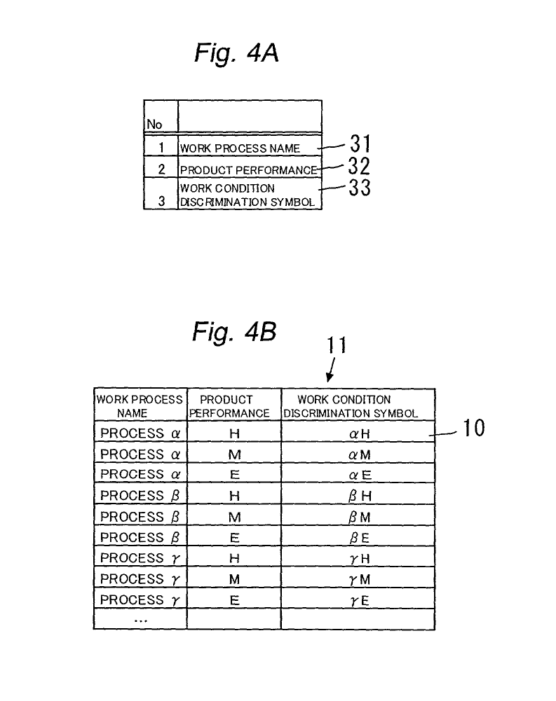

FIG. 4 is a diagram showing the structure of the product work condition assignment data 10 and an example of the third manufacturing method information 11. The product work condition assignment data 10 has the data structure shown in FIG. 4A. The data structure is made up of data item fields such as a work process name field 31, a product performance field 32, and a work condition discrimination symbol field 33. The present embodiment specifies and manages product performance by setting a value for the product performance field 32 as follows. A value of “H” is set for the product performance field 32 to indicate “High Performance”; “E” is set to indicate “Economical Version”; and “M” is set to indicate “Middle Version”. Furthermore, the work condition discrimination symbol field 33 is expressed by a combination of values of the work process name field 31 and the product performance field 32. For example, when manufacturing a product having the “H”-level performance in a process α, the work condition to be applied is indicated by the symbol “αH”. As shown in FIG. 3 and described above, the work condition discrimination symbol identifies each piece of work condition data. FIG. 4B shows an example of the third manufacturing method information 11 made up of pieces of product work condition assignment data 10.

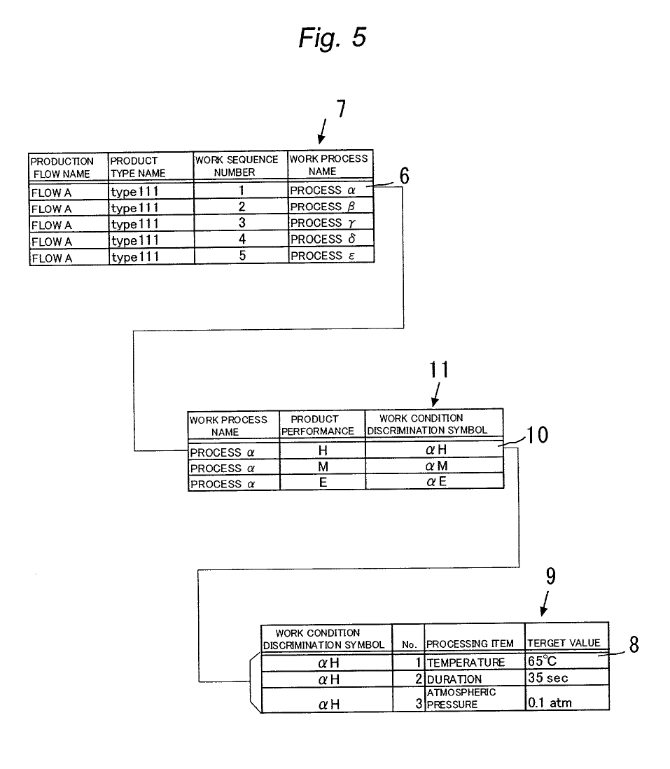

FIG. 5 is a diagram showing the relations among the production flow data 6, the work condition data 8, and the product work condition assignment data 10. As shown in the figure, the work process name field in the production flow data 6 corresponds to that in the product work condition assignment data 10. Furthermore, the work condition discrimination symbol field in the product work condition assignment data 10 corresponds to that in the work condition data 8. That is, given the name of a product to be produced and its product performance, it is possible to search for and obtain corresponding production flow data using the product type name as a search key. Then, the corresponding work condition discrimination symbol can be obtained by using the work process included in the obtained product flow data 6 and the product performance as search keys. Finally, by collecting each piece of the work condition data 8 indicated by the obtained work condition discrimination symbol, it is possible to obtain specific work condition items for each work process and their contents.

As can be seen from the above description, the present invention is advantageous in that it does not manage a production flow as a single piece of data but as a set of pieces of data instead, and furthermore simplifies the structure of the data set as much as possible so as to eliminate duplicate registration of information as well as simplifying addition/deletion of a work process to/from a production flow. For example, consider a case in which the work condition indicated by the work condition discrimination symbol “αH” is to be applied to another work process. With a conventional data structure, it is necessary to newly register and manage data including information such as the temperature “65°C.” and the time “35 sec”. However, if pieces of data having a simple structure and associated with one another are registered and managed as shown in FIG. 5, it is possible to assign the same condition “αH” to another process by inserting a single piece of product work condition assignment data 10, eliminating the need for duplicating detailed work condition data and managing them. Furthermore, since addition, alteration, and deletion of a production flow or a work condition can be carried out by inserting or deleting a piece of data, it is not necessary to shut down the system to change the data definition.

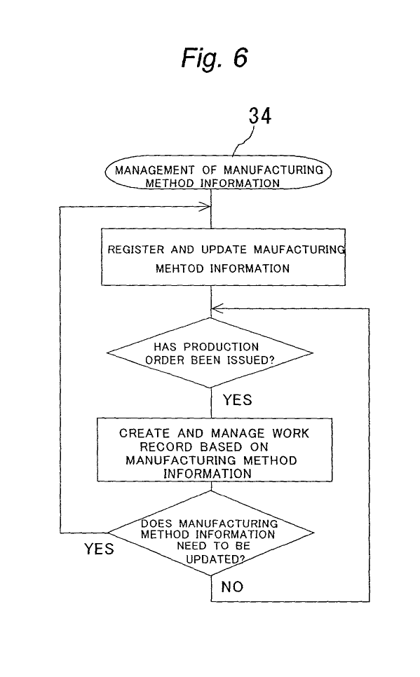

FIG. 6 is a flowchart 34 showing a manufacturing method management procedure. As shown in the figure, based on the data structure described above, manufacturing method information is registered and after a production order is issued, a corresponding work record is created and managed according to the registered manufacturing method information. Thus, it is simple to manage, register, and update manufacturing method information as necessary.

Next, description will be made of work record information managed by the production management system. The present embodiment manages three types of work record information: the first work record information 13, the second work record information 15, and the third work record information 17. The first work record information 13 is made up of pieces of product work record data 12 each indicating a work result for a product; the second work record information 15 is made up of pieces of process record data 14 each indicating a work result for a process; and the third work record information 17 is made up of pieces of applying condition data 16 each indicating a work condition applied to work.

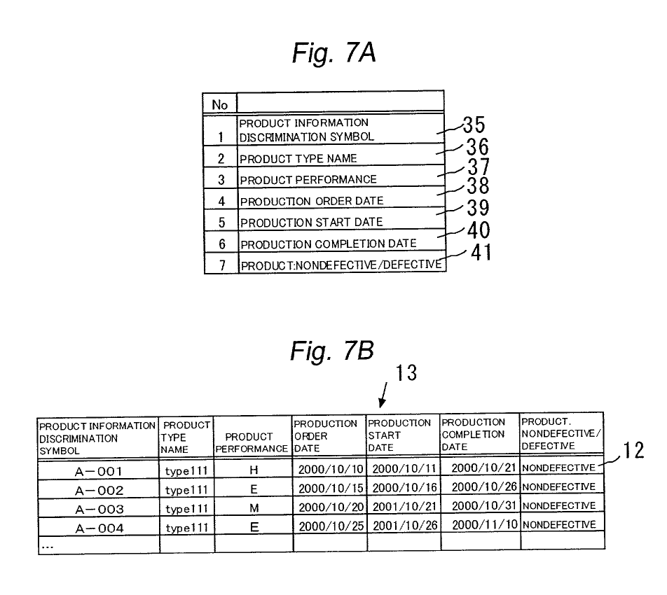

FIG. 7 is a diagram showing the structure of the product work record data 12 and an example of the first work record information 13. As shown in FIG. 7A, the product work record data 12 has a structure made up of data items such as a product information discrimination symbol field 35, a product type name field 36, a product performance field 37, a production order date field 38, a production start date field 39, a production completion date field 40, and a “product: nondefective/defective” field 41. A product information discrimination symbol 35 is assigned to each production order. This symbol may be automatically determined, or alternatively a symbol entered with a production order by a worker may be used as this symbol. The product type name and the product performance are entered as information constituting a production order. The production order date field 38, the production start date field 39, the production completion date field 40, and the “product nondefective/defective” field 41 hold information input from the terminal 4 in FIG. 1 by a worker, etc. FIG. 7B is a diagram showing an example of the first work record information 13 made up of pieces of product work record data 12.

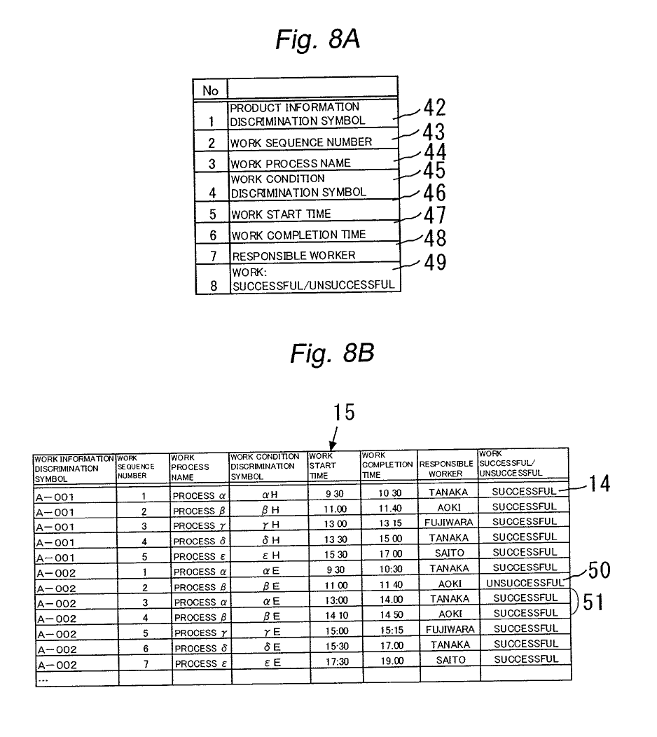

FIG. 8 is a diagram showing the structure of the process record data 14 and an example of the second work record information 15. As shown in FIG. 8A, the process record data 14 has a structure made up of data items such as a product information discrimination symbol field 42, a work sequence number field 43, a work process name field 44, a work process discrimination symbol field 45, a work start time field 46, a work completion time field 47, a responsible worker field 48, and a “work: successful/unsuccessful” field 49. FIG. 8B is a diagram showing an example of the second work record information 15 made up of pieces of the process record data 14. The product information discrimination symbol 42 in the figure corresponds to the product information discrimination symbol 35 in FIG. 7. On the other hand, the work sequence number field 43, the work process name field 44, the work process discrimination symbol field 45 hold information selected from the first manufacturing method information 7 and the third manufacturing method information 9. The work start time field 46, the work completion time field 47, the responsible worker field 48, the “work: successful/unsuccessful” field 49 hold information input from the terminal 4 in FIG. 1 by a worker.

The data denoted by reference numerals 50 and 51 indicate that the process β first failed, and was carried out again after the process α. Which process is to be inserted after the process β fails is determined by referring to the corresponding insertion production flow name field 22 included in the first manufacturing method information 7 in FIG. 2B. In the present embodiment, when a worker enters the information “unsuccessful”(termination) from the terminal 4, the production management system refers to the manufacturing method information 7. If a corresponding insertion production flow name is registered, the production management system automatically creates work record data for the work processes included in the insertion production flow. It should be noted that when the second work record information 15 is created, each insertion production flow name may be obtained and registered as the value of a data item field in the respective process record data 14 beforehand. In this case, the amount of the work record information to be recorded increases; however it is possible to shorten time it takes to obtain an insertion production flow when required.

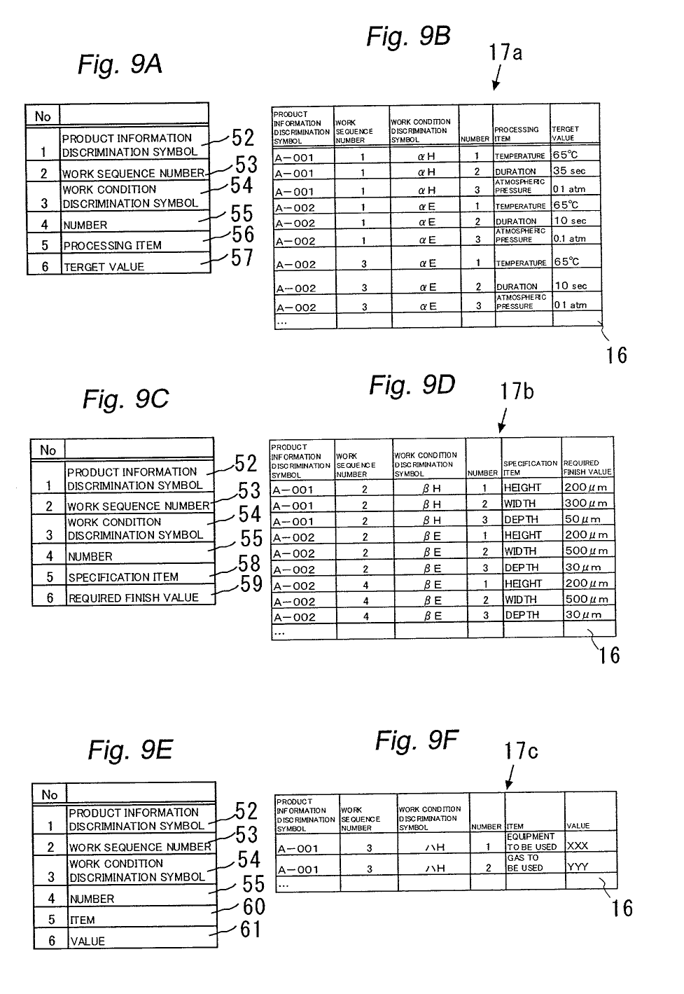

FIG. 9 is a diagram showing the structure of the applying condition data 16 and an example of the third work record information. As in the case of the work condition data 8 included in the manufacturing method information, the present embodiment defines three types of data structures for the applying condition data 16 each used according to a respective type of data to be managed.

FIG. 9A is a diagram showing the data structure of the applying condition data 16 for managing work process conditions such as temperature. FIG. 9B is a diagram showing an example of third work record information 17a made up of pieces of the applying condition data 16. The product information discrimination symbol 52 in the figure corresponds to the product information discrimination symbol 35 in FIG. 7 and the product information discrimination symbol 42 in FIG. 8. A work sequence number field 53, a work condition discrimination symbol field 54, a number field 55, a process item field 56, and a process value field 57 each hold information selected from the second manufacturing method information.

FIG. 9C is a diagram showing the data structure of applying condition data 16 for managing a specification that must be satisfied for work. The specification concerns dimensions, etc. and is managed as a work condition. FIG. 9D is a diagram showing an example of third work record information 17 b made up of pieces of such applying condition data 16. In addition, the present embodiment defines the data structure shown in FIG. 9E which can be applied to any arbitrary management items, and FIG. 9F is a diagram showing an example of third work record information 17 c made up of pieces of applying condition data 16 having such a data structure.

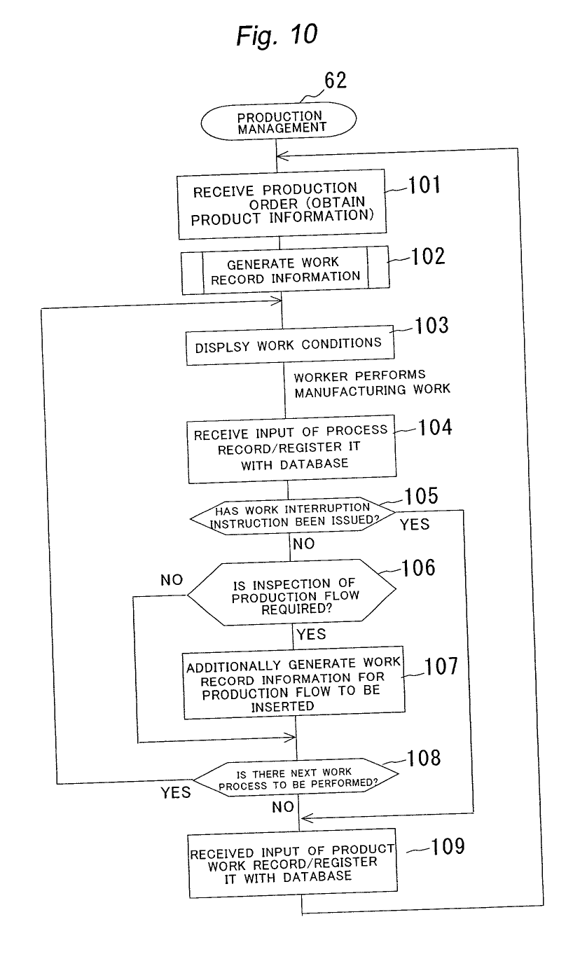

This completes the detailed description of information managed by the production management system according to the present embodiment and the data structures of the information. Next, description will be made of processing performed by the production management system with reference to FIGS. 10, 11, and 12. The flowchart 62 in FIG. 10 shows processing performed by the production management system of the present embodiment. The production management system receives a production order from the terminal 4 shown in FIG. 1 at step 101, and obtains product information such as the type and the performance of the product to be manufactured. The production management system then obtains necessary information from the manufacturing method information database based on the obtained product information to generate work record information at step 102.

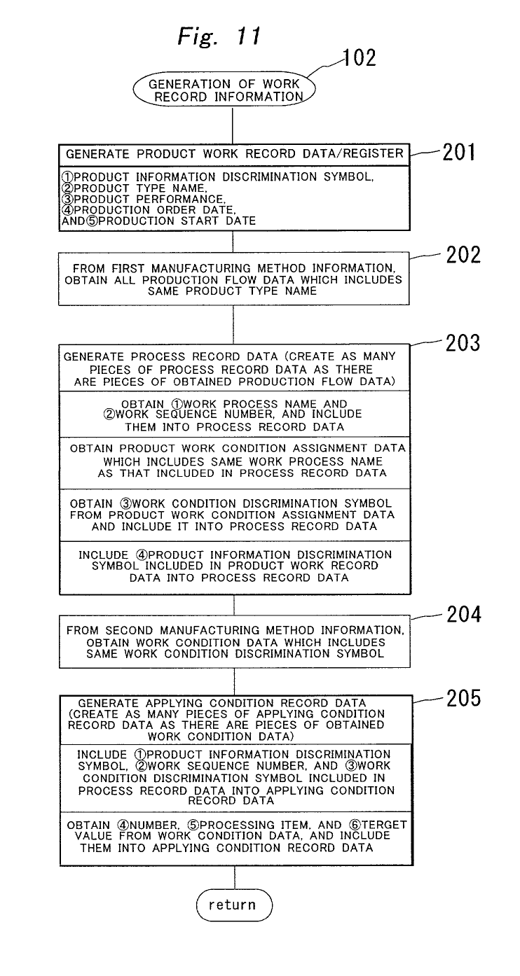

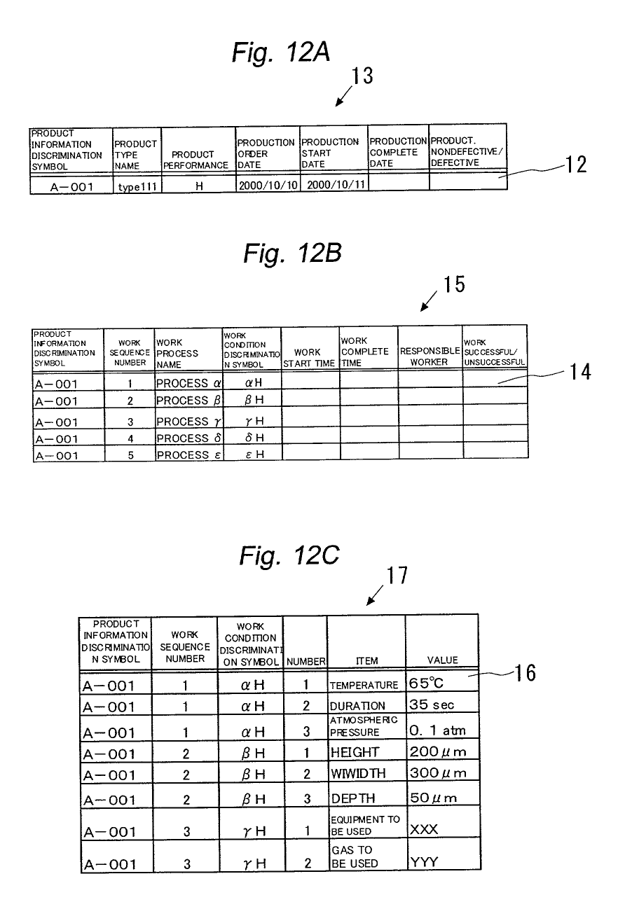

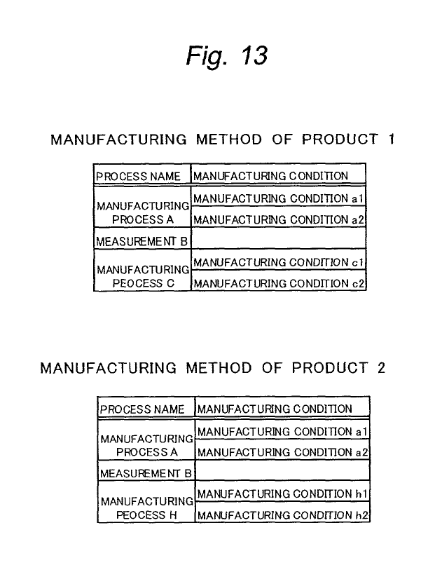

FIG. 11 is a flowchart showing the process of generating work record information at step 102. As described above, the work record information of the present embodiment comprises the first work record information made up of pieces of product work record data, the second work record information made up of pieces of process record data, and the third work record information made up of pieces of applying condition record data. Referring to the flowchart, product work record data is first generated at step 201. Specifically, the generation step of product work record data newly creates data having a structure as described in FIG. 7A, and sets values, one each for the product information discrimination symbol field, the product type name field, the product performance field, the production order date field, and the production start date field, respectively. For the product type name field and the product performance field, step 201 sets values obtained as manufacturing method information. The product information discrimination symbol field may hold a value entered from a terminal as a piece of manufacturing method information, or alternatively a serial number may be automatically set for the field. The production order date field and the production start date field may also each hold a date entered from a terminal as a piece of manufacturing method information, or alternatively a preset date may be automatically set for each field. For example, a date at which product work record data was generated may be regarded as the production order date and the following day as the production start date, and these dates are automatically assigned. FIG. 12A shows an example of product work record data generated as described above. No values are set for the production completion date field and the “product: nondefective/defective” field at this time point.

From the first manufacturing method information, step 202 shown in FIG. 11 selects production flow data whose product type name coincides with that included in the product work record data at step 201. This makes it possible to obtain work processes to be performed and thereby generate process record data for each work process.

The process record data is generated at step 203 as follows. Step 203 newly creates as many pieces of data (process record data) having the structure shown in FIG. 8A as there are pieces of production flow data obtained at step 202, and includes the work process name and the work sequence number of each piece of the obtained production flow data into one of the pieces of the created data.

After that, data is set for each piece of the process record data as follows. From the third manufacturing method information, step 203 first selects product work condition assignment data which includes the same work process name as that included in the process record data. Then, from the obtained product work condition assignment data, step 203 selects data which includes the same product performance as that entered as a piece of product information to obtain an assigned work condition discrimination symbol, and include it into the process record data. Furthermore, the same product information discrimination symbol as that included in the product record data is included into the process record data. This procedure is repeated for each piece of the created process record data. FIG. 12B shows an example of process record data generated as described above. The work start time field, the work completion time field, the responsible worker field, and the “work: successful/unsuccessful” field are left blank at this time point.

From the second manufacturing method information, step 204 shown in FIG. 11 selects work condition data whose work condition discrimination symbol coincides with that obtained at step 203. This work condition data is used to obtain information on work conditions to be included in applying condition record data.

The applying condition record data is generated at step 205 as follows. Step 205 first newly creates as many pieces of applying condition record data each having the structure shown in FIGS. 9A, 9C, or 9E as there are pieces of the obtained work condition data. If the structure of the obtained work condition data is the same as that shown in FIG. 3A, FIG. 3C, or FIG. 3E, step 205 creates applying condition record data having the structure shown in FIG. 9A, FIG. 9C, or FIG. 9E, respectively. Furthermore, the same product information discrimination symbol, work sequence number, and work condition discrimination symbol as those included in the process record data are included in each piece of created applying condition record data.

After that, step 205 includes the values of the number field, process item field, and target value field (or the number field, specification item field, and required finish value field, or the number field, item field, and value field) included in a respective piece of the obtained work condition data into each piece of the created applying condition record data. FIG. 12C shows an example of applying condition record data created as described above.

This completes the description of generation of work record information at step 102. Referring back to FIG. 10, description will be made of the subsequent steps performed by the production management system. At step 103, the work record information created at step 102 is displayed on the screen of the terminal 4 shown in FIG. 1 for each work process. More specifically, one piece of process record data (record data for a single process) and the corresponding pieces of applying condition data are displayed on the screen as a set. With this arrangement, the worker can perform production work while checking the work conditions displayed on the screen.

Furthermore, at step 104, the production management system displays work conditions on the screen and receives input of a work record at the same time. That is, the worker can input information such as values for the work start time field, the work completion time field, the responsible worker field, and the “work: successful/unsuccessful” field, which have been left blank at step 203. More specifically, the input information is entered in blank fields in each piece of process record data 14 shown in FIG. 12B, and the resultant process record data is registered in the corresponding database.

At step 105, if the worker has entered an instruction requesting for interruption of the work, the system receives the instruction, and proceeds to step 109. If no instruction requesting for the interruption is entered and the message “unsuccessful” (termination) is input as the value for the “work: successful/unsuccessful” field at step 104, it is determined whether insertion of a production flow is required, at step 106. Whether there exists a production flow to be inserted may be determined by searching the first manufacturing method information shown in FIG. 2B, or alternatively the production flow to be inserted may be included in the process record data at step 203 in FIG. 11 so that the process record data can be referred to at step 106. If it is necessary to insert a production flow, work record information for the production flow to be inserted is additionally generated by performing the same processes as those at steps 201 through 205 in FIG. 11 at step 107.

If there exists the next work process to be performed, the processes at steps 103 through 107 are repeated for the next process record data and the corresponding applying condition data. If all work processes have been performed, the system displays a screen prompting input of the production completion date and information indicating whether the product is defective or nondefective, and receives the product work record at step 109. The information thus input by the worker is entered in blank fields of the product work record data in FIG. 12A.

The production management system repeats the procedure described above to generate, store, and mange work record information each time a production order is issued.

Incidentally, to manage the work record information, the present embodiment classifies it into three types of information: the first work record information made up of pieces of product work record data, the second work record information made up of pieces of process record data, and the third work record information made up of pieces of applying condition data. However, the work record information may be set to have a single data structure and thereby managed collectively, and only the manufacturing method information may be divided into three types of information for management.

Further, the present embodiment defines a insertion production flow name as a data item of production flow data as shown in FIG. 2A, and realizes a flow insertion function by performing steps 106 and 107 in FIG. 10. However, the object of the present invention to efficiently manage many pieces of complicated information can be achieved without using this function. That is, the flow insertion function is not essential to the present invention.

Still further, the present embodiment handles work process names, etc. as text information. However, an identification symbol may be assigned to each work process so as to manage work processes using identification symbols. In this case, the corresponding relationships between the identification symbols and the text names indicating the work processes may be stored separately, and the text may be output onto the screen based on the corresponding relationships when work conditions are displayed on the screen.

It should be noted that the present embodiment indicates, in addition to a production management system of the present invention, a production management method, a computer-readable medium storing production management information, a production management program, and a computer-readable medium storing the production management program according to the present invention. For example, the flowchart shown in FIGS. 10 and 11 shows a production management method of the present invention. Furthermore, a program incorporated into the server computer 3 and the terminal 4 in FIG. 1 can be regarded as a production management program according to the present invention. The manufacturing method information 1 and the work record information 2 shown in FIG. 1, on the other hand, show a computer-readable medium storing production management information according to the present invention.

A production management system according to the present invention define three types of data such as the production flow data 6, the work condition data 8, and the product work condition assignment data 10, and creates and registers the manufacturing method information 1 based on the three data formats so as to generate the work record information 2 by combining the data as necessary. This system eliminates the need for duplicating the manufacturing method information for management even when it is necessary to perform production management of a large number of products, saving the storage area and facilitating updating of the database. Furthermore, it is possible to manage a number of various production flows by employing as many combinations of the data.

Further, the production management system can indicate generated work record information 2 on a display apparatus before the work is started, making it possible for the worker to check the work conditions and add work records at the time of completion of the work. Thus, it is possible to register all necessary work records with the database.

In addition, if not only the manufacturing method information 1 but also the work record information 2 is managed by defining three types of data, specifically the product work record data 12, the process record data 14, and the applying condition data 16 in the case of the work record information 2 (so as to generate the work record information 2 based on these data formats), it is possible to more efficiently manage the work record information, making it convenient to statistically process the records afterwards.

Furthermore, if the production flow data 6 includes the insertion production flow name field 22 as one of its data items, which indicates processes to be inserted after the original work process in a predetermined case, it is possible to quickly determine processes to be subsequently performed when it is necessary to perform the original work process again. In this case, the system may be provided with a function to automatically regenerate work record information, making it possible for even an inexperienced worker to smoothly reexecute a process.

A production management program of the present invention can be incorporated into the terminal 4 or the server computer 3, or both shown in FIG. 1 separately by distributing it in a computer-readable medium or online, making it possible to construct the above-detailed production management system with the same effect as that described above.

It is further understood that the foregoing description is a preferred embodiment of the disclosed apparatus and that various changes and modifications may be made in the invention without departing from the spirit and scope thereof.

The entire disclosure of a Japanese Patent Application No. 2001-060527, filed on Mar. 5, 2001 including specification, claims drawings and summary, on which the Convention priority of the present application is based, are incorporated herein by reference in its entirety.

What is claimed is:

1. A production management system for, by use of a computer, managing a product manufacturing method and a work record for production of a product, said production management system comprising:
a manufacturing method management database storing
first manufacturing method information composed of pieces of production flow data each indicating a type and a sequence number of a work process for producing a product,
second manufacturing method information composed of pieces of work condition data each indicating a work condition for performing a work process, and
third manufacturing method information composed of pieces of product work condition assignment data each assigning a work condition suitable for production of a product to a work process,
wherein said first manufacturing method information, said second manufacturing method information, and said third manufacturing method information are registered in said manufacturing method management database in such a way that they are associated with one another;
production flow data obtaining means for, based on product information supplied from an input apparatus, selecting and obtaining production flow data for a product indicated by the product information from said first manufacturing method information;
product work condition assignment data obtaining means for, from said third manufacturing method information, selecting and obtaining product work condition assignment data which includes the same work process as that included in the obtained production flow data and the same product information as said product information;
work condition data obtaining means for, based on the obtained product work condition assignment data, selecting and obtaining work condition data indicating a work condition assigned from said second manufacturing method information by the product work condition assignment data;
work record data generating means for combining predetermined data items included in the obtained production flow data, the obtained product work condition assignment data, and the obtained work condition data to generate work record data; and
a work record management database in which work record information composed of pieces of generated work record data is registered.

2. The production management system as claimed in claim 1, further comprising:
work record display means for displaying desired work record data selected from said work record information on a display apparatus; and
work record update means for adding information on a work result supplied from an input apparatus to said work record information to update said work record management database.

3. The production management system as claimed in claim 1, wherein said production flow data has a structure made up of data items including:
a production flow identifier for identifying a production flow composed of pieces of the production flow data;
a product identifier for identifying a product;
a work process identifier for identifying a work process; and
a sequence number of the work process.

4. The production management system as claimed in claim 1, wherein said product work condition assignment data has a structure made up of data items including:
a work process identifier for identifying a work process;
a product type indicating a type of a product; and
a work condition identifier for identifying a work condition.

5. The production management system as claimed in claim 1, wherein said work condition data has a structure made up of data items including:
a work condition identifier for identifying the work condition data;
a setting item; and
a setting value.

6. The production management system as claimed in claim 5, wherein said production management system manages a condition of a process to be performed on a work target based on the setting item and the setting value of said work condition data.

7. The production management system as claimed in claim 5, wherein said production management system manages a finish specification to be satisfied by a work target based on the setting item and the setting value of said work condition data.

8. The production management system as claimed in claim 1, wherein the work record information registered in said work record management database comprises:
first work record information composed of pieces of product work record data each indicating a work result for a product;
second work record information composed of pieces of process record data each indicating a work result for a work process; and
third work record information composed of pieces of applying condition data each indicating a work condition applied to work.

9. The production management system as claimed in claim 8, wherein said product work record data has a structure made up of data items including:
a product production order date;
a product production start date;
a product production completion date; and
information indicating whether a manufactured product is nondefective or defective.

10. The production management system as claimed in claim 8, wherein said process record data has a structure made up of data items including:
a work process start time;
a work process completion time;
a responsible worker; and
information indicating whether a performed work is successful or unsuccessful.

11. The production management system as claimed in claim 1, wherein said production flow data has a structure made up of data items including:
a first production flow identifier for identifying a production flow composed of pieces of the production flow data itself;
a product identifier for identifying a product;
a work process identifier for identifying a work process;
a sequence number of the work process; and
a second production flow identifier for specifying an insertion production flow indicating another work process to be inserted after said work process in a predetermined case.

12. The production management system as claimed in claim 11, further comprising:
insertion production flow data obtaining means for selecting and obtaining production flow data for a production flow specified by said second production flow identifier in said predetermined case;
wherein said production management system generates work record data for a work process included in the obtained insertion production flow data to additionally register the generated work record data with said work record management database by use of said product work condition assignment data obtaining means, said work condition data obtaining means, and said work record data generating means.

13. A method of producing a semiconductor device, said method using the production management system as claimed in claim 1.

14. A production management program for managing a product manufacturing method and a work record for production of a product, said production management program causing a computer to realize the functions of:
accessing a manufacturing method management database which stores
first manufacturing method information composed of pieces of production flow data each indicating a type and sequence number of a work process for producing a product,
second manufacturing method information composed of pieces of work condition data each indicating a work condition for performing a work process, and
third manufacturing method information composed of pieces of product work condition assignment data each assigning a work condition suitable for production of a product to a work process, wherein said first manufacturing method information, said second manufacturing method information, and said third manufacturing method information are registered in said manufacturing method management database in such a way that said first, second, and third manufacturing method information are associated with one another;
based on product information supplied from an input apparatus, selecting and obtaining product flow data for a product indicated by the product information from said first manufacturing method information;
from said third manufacturing method information, selecting and obtaining product work condition assignment data which includes the same work process as that included in the obtained production flow data and the same product information as said product information;
based on the obtained product work condition assignment data, selecting and obtaining work condition data indicating a work condition assigned from said second manufacturing method information by the product work condition assignment data; and
combining predetermined data items included in the obtained production flow data, the obtained product work condition assignment data, and the obtained work condition data to generate work record data.

15. A production management program for managing a product manufacturing method and a work record for production of a product, said production management program causing a computer to realize the functions of:
accessing a manufacturing method management database which stores
first manufacturing method information composed of pieces of production flow data each indicating a type and a sequence number of a work process for production of a product,
second manufacturing method information composed of pieces of work condition data each indicating a work condition for performing a work process, and
third manufacturing method information composed of pieces of product work condition assignment data each assigning a work condition suitable for production of a product to a work process,
wherein said first manufacturing method information, said second manufacturing method information, and said third manufacturing method information are registered in said manufacturing method management database in such a way that said first, second, and third manufacturing method information are associated with one another, and
wherein said production flow data has a structure made up of data items including
a first production flow identifier for identifying a production flow,
a product identifier for identifying a product,
a work process identifier for identifying a work process,
a sequence number of the work process, and
a second production flow identifier for specifying an insertion production flow indicating another work process to be inserted after said work process in a predetermined case;
based on product information supplied from an input apparatus, selecting and obtaining product flow data for a product indicated by the product information from said first manufacturing method information;
from said third manufacturing method information, selecting and obtaining product work condition assignment data which includes the same work process as that included in the obtained production flow data and the same product information as said product information;
based on the obtained product work condition assignment data, selecting and obtaining work condition data indicating a work condition assigned from said second manufacturing method information by the product work condition assignment data;
combining predetermined data items included in the obtained production flow data, the obtained product work condition assignment data, and the obtained work condition data to generate work record data;
selecting and obtaining insertion production flow data specified by said second production flow identifier in said predetermined case; and
adding work record data to be inserted generated based on said insertion production flow data to said generated work record data to update work record information.
